(19) United States
(12) Patent Application Publication
(10) Pub. No.: US 2005/0288032 A1
(43) Pub. Date: Dec. 29, 2005

(54) Resource allocation system and method

(76) Inventors: Manuel G. Orellana, Long Valley, NJ (US); John H. Stothoff, Flemington, NJ (US)

Correspondence Address: HARNESS, DICKEY & PIERCE, P.L.C., P.O. Box 8910, Reston, VA, 20195, US

(21) Appl. No.: 10/878,281

(22) Filed: Jun. 29, 2004

(51) Int. Cl. H04Q 7/20

(52) U.S. Cl. 455/452.1

(57) ABSTRACT

A resource allocation system and method including a plurality of sector systems and an allocation unit configured to allocate at least one of the sector systems to at least one antenna supporting a cell of a plurality of cells when the cell needs more radio resources to process increased subscriber signal demand.

### BACKGROUND

1. Technical Field

The present invention relates generally to resource allocation and more particularly to sector system resource allocation.

2. Description of the Related Art

Wireless networks such as those involving time division based technology (e.g., TDMA, GSM, etc. technologies) or spread spectrum (e.g., CDMA, UMTS, etc technologies) are typically configured with fixed sector system capacity per geographic sector area. A sector system is a system that processes calls for a specific sector area of a mobile cell. Typically, a mobile cell itself includes one or more sector systems to support mobile subscribers within the mobile cell's geographic coverage area which includes one or more sector areas. For example, the mobile cell may include one omni-directional antenna supported by one dedicated sector system for the entire mobile cell. Alternatively, the mobile cell may include several directional antennas, each directional antenna supported by one dedicated sector system for each respective sector area of the mobile cell.

In processing calls, each sector system may provide radio capacity to a specific sector area of a mobile cell within a cellular network served by a set of transmit and receive antennas located to transmit and receive specific radio signals within the sector system's associated sector area. The capacity of each sector system installed in each base station (BS) supporting a mobile cell is configured to support peak usage capacity.

Usage patterns may be sampled in a given mobile cell and sector systems may be provided that satisfy the radio capacity demands for the peak periods of the mobile cell. These sector systems may be dedicated to the base stations in which they may be installed and the antennas associated with the base stations. As RF converters may be installed in a particular base station, they may be not used by any other base stations. As usage in a given sector area of a given mobile cell grows beyond the capacity of the sector system supplying radio capacity to the sector of the mobile cell, more RF converters may be installed in the base station supporting the cell, effectively increasing the capacity of that sector system.

Typically, wireless networks use the most radio capacity during the morning and the evening. Accordingly, base stations may be provided sector systems with a radio capacity to meet the demand of these peak periods. For the remainder of the day, however, the wireless network or networks may not be utilized to the extent that they may be capable because traffic demands may be relatively low. As a result, much of the radio capacity deployed at a base station supporting a mobile cell may be used only to meet demand during peak periods. Meanwhile, much of the sector capacity sits idle for the remainder of the day. A typical telecommunications system where sector capacity often sits idle is shown in FIG. 1.

FIG. 1 depicts a schematic diagram of a portion of a typical telecommunications system designated generally as 100. System 100 serves a number of communication terminals. System 100 includes a Public Switched Telephone Network (PSTN) 105 that provides connectivity for a wireless communication system to other communication systems within and connected to the PSTN 105. The PSTN 105 may be connected to a Mobile Switching Center (MSC) 110. The MSC 110 may route or “switch” calls between wireless terminals or, alternatively, between a wireless terminal and a wireline terminal in the PSTN 105. The MSC 110 may also be connected to a Base Station Controller (BSC) 120 which controls a plurality of base stations providing service to a plurality of cells 130ᵢ₋ₙ . As depicted in FIG. 1, each cell 130, is schematically represented by a hexagon. In practice, however, each cell 130ᵢ usually has an irregular shape that depends, for example, on the topography of the terrain serviced by system 100. Typically, each cell 130ᵢ contains a corresponding base station. The base station may be connected to transmit/receive antennas and include sector systems. Each sector system serves a single sector area and may include an RF converter to communicate with wireless terminals. Many of the sector systems of the telecommunications system of FIG. 1 have unused capacity during non-peak capacity time periods as shown in FIG. 2.

FIG. 2 illustrates a block diagram of a prior art base station. As shown in FIG. 2, BS 210ᵢ may be connected to the BSC 120 and an antenna site 270i. BS 210ᵢ includes an interface 220 for communicating with the BSC 120, and a plurality of sector systems 230ᵢ₋ₖ. The interface 220 processes the signals from the BSC 120 and disperses each signal to an appropriate sector system 230ᵢ₋ₖ.

Each sector system 230ᵢ₋ₖ processes the signals sent from the interface 220 and prepares them to be sent to associated transmit and receive antenna sets 275ᵢ₋ₖ within antenna site 270ᵢ. Each sector system 230ᵢ may include baseband processors 233ᵢ₋ₙ that provide baseband processing of the received signals from the interface 220, radio frequency (RF) converters 236ᵢ₋ₙ which may be radios that convert the signals processed by the baseband processors 233ᵢ₋ₙ for transmission to the antenna site 270ᵢ. The combiner 239 receives the signals from each of the RF converters 236ᵢ₋ₙ and combines and amplifies the signals into a BS signal for transmission over the sector system signal lines 250ᵢ₋ₖ to the antenna site 270ᵢ. The antenna site 270ᵢ includes at least one associated transmit and receive antenna set 275ᵢ for transmission of the BS signals that support mobile communications between the BS 210ᵢ and a mobile subscriber.

Conversely, transmit and receive antenna sets 275ᵢ₋ₖ of the antenna site 270ᵢ receive mobile communications from mobile subscribers and send the received signals to their respective sector systems 230ᵢ₋ₙ where the signals may be split by a combiner 239 and distributed to RF converters 236ᵢ₋ₙ and baseband processors 233ᵢ₋ₙ. The signal may be then sent to the interface 220 where it then continues on to a termination point.

### SUMMARY OF THE INVENTION

In an example embodiment of the invention, a resource allocation system for a wireless communications system includes a plurality of sector systems. The resource allocation system further includes an allocation unit configured to dynamically allocate at least one of the sector systems to at least one antenna supporting a cell of a plurality of cells when the cell needs more radio resources to process increased subscriber signal demand.

In another example embodiment, a method includes determining that a cell of a plurality of cells needs more radio resources. The method further includes dynamically allocating at least one sector system of a plurality of sector systems to at least one antenna supporting the cell when the cell needs more radio resources to process increased subscriber signal demand.

### BRIEF DESCRIPTION OF THE DRAWINGS

Example embodiments of the present invention are described below in conjunction with the accompanying drawings.

FIG. 1 is a schematic diagram of a prior art wireless telecommunications system.

FIG. 2 illustrates a block diagram of a prior art base station.

FIG. 3 illustrates a block diagram of a mobile communication system including a central allocation unit according to an example embodiment of the invention.

FIG. 4 illustrates a flow diagram for a central allocation unit according to an example embodiment of the invention.

FIG. 5 illustrates a block diagram of a central allocation unit according to an example embodiment of the invention.

### DETAILED DESCRIPTION OF EXAMPLE EMBODIMENTS

Additional features and advantages of the invention will be more fully apparent from the following detailed description of example embodiments, the appended claims and the accompanying drawings.

An example embodiment of the invention provides a capability to dynamically allocate sector system capacity to support mobile cells associated with a base station controller. This may be achieved by disassociating sector systems from specific antennas supporting a mobile cell and allocating or routing unused sector systems to antennas of at least one other mobile cell that needs the capacity without physically moving the sector systems. The need may be based on historical measurements of capacity requirements at certain times of day. At times of the day when radio capacity may be needed most at a specific sector area serviced by a sector system of a specific mobile cell, radio resources may be dynamically allocated to the sector area of that mobile cell by allocating a sector system with sufficient capacity from another mobile cell.

In an example embodiment, base stations may be geographically separate in separate cells, but the sector systems within each base station may be centrally controlled and made available to other cells. The use of existing base station resources to assist other base stations in cell coverage helps reduce implementation and design costs of cellular networks. Moreover, the example embodiment enables the reallocation of sectors to other cells with little to no modification to existing base stations.

The remainder of the detailed description is arranged as follows. First disclosed is a radio access portion of a wireless network including a controller that dynamically allocates sector systems throughout the wireless network. Next disclosed is the logic for a central allocation unit that controls the allocation of sector systems throughout the wireless network. Lastly disclosed is a central allocation unit according to an example embodiment of the invention.

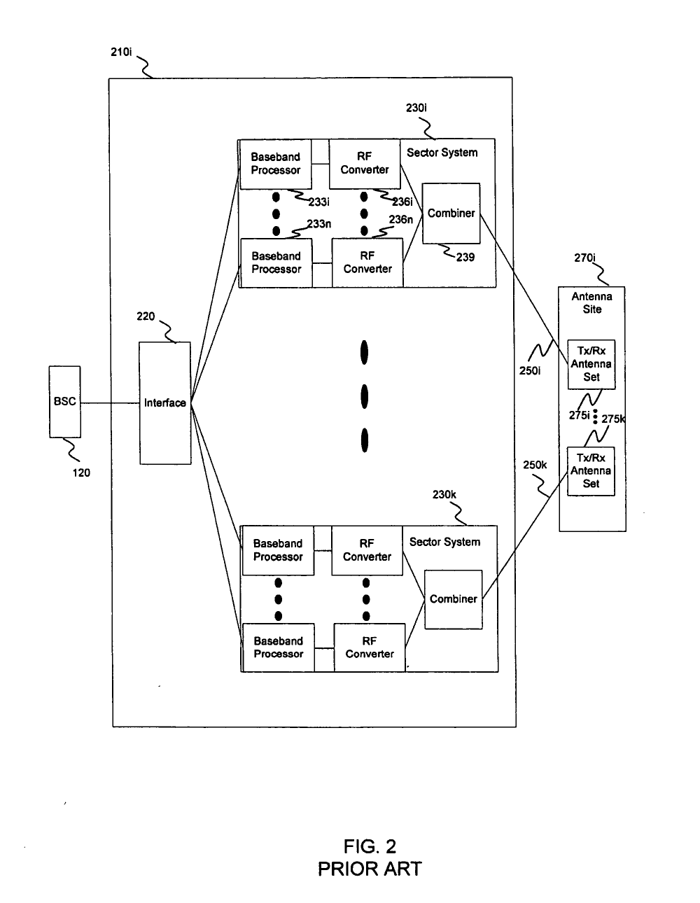

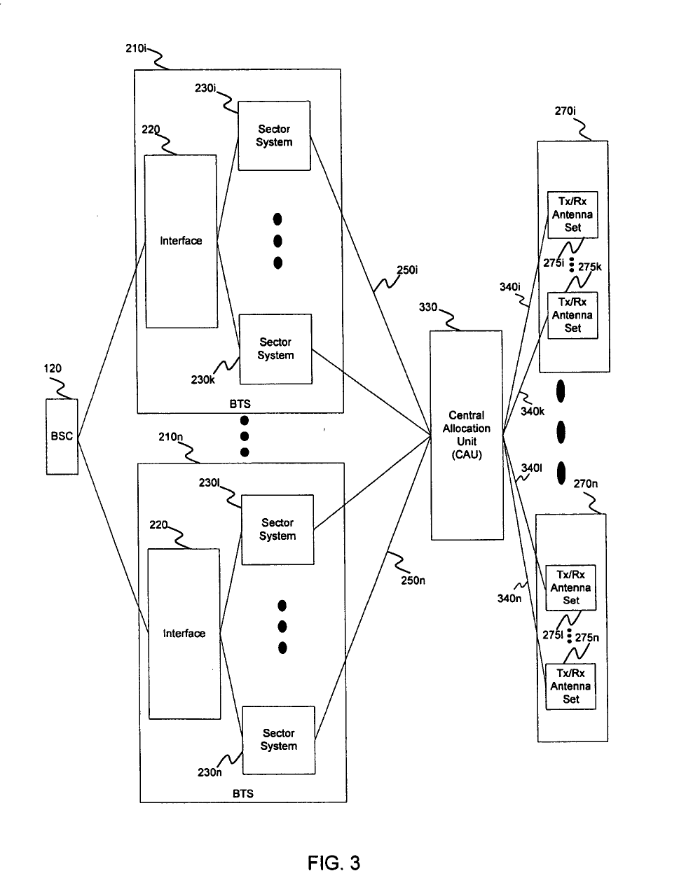

FIG. 3 illustrates a block diagram of a mobile communication system including a central allocation unit according to an example embodiment of the invention. As shown in FIG. 3, the BSC 120 and BSs 210ᵢ₋ₙ may have the same general structure as the BSC 120 and BS 210ᵢ, respectively, in FIG. 2. However, instead of the sector system signal lines 250ᵢ₋ₙ connecting the BSs 210ᵢ₋ₙ to their respective antenna sets 275ᵢ₋ₖ, the sector system signal lines 250ᵢ₋ₙ may be connected to the CAU 330 which may be interposed between the BSs 210ᵢ₋ₙ and the antenna sets 275ᵢ₋ₙ within the antenna sites 270ᵢ₋ₙ. The CAU 330 may connect to the antenna sites 270ᵢ₋ₙ via cell communication lines 340ᵢ₋ₙ. Furthermore, the sector systems 230ᵢ₋ₙ need not include each element of the prior art sector systems. Again, a function of a sector system is to process calls for a specific sector area. As such, the sector systems 230ᵢ₋ₙ may be scaled down to include less call processing equipment than conventional sector systems while elements that are typically associated with conventional sector systems are distributed to other parts of the network, or not used at all. For example, while a sector system may include baseband processors, amplifiers that may be within a conventional sector system may instead be located at the antenna sets 275ᵢ₋ₙ themselves, at the CAU 330, or at repeaters between the BSs 210ᵢ₋ₙ and the antenna sets 275ᵢ₋ₖ. Likewise, a combiner may not be part of the sector systems 230ᵢ₋ₖ, but instead may be located at various locations along the path between the BSs 210ᵢ₋ₙ and the antenna sets 275ᵢ₋ₖ. Different variations of components and connections may be implemented without detracting from one of the sector systems' features of processing calls for a specific sector area.

The CAU 330 allocates sector systems 230ᵢ₋ₙ to and from each of the antenna sets 275ᵢ₋ₙ within antenna sites 270ᵢ₋ₙ in the mobile cells 130ᵢ₋ₙ. Such allocation allows for reuse of sector resources throughout a mobile network where they may be needed. The CAU 330 communicates with the antenna sets 275ᵢ₋ₙ and BSs 210ᵢ₋ₙ using communication trunks. These communication trunks may be in the form of insulated coax or other medium that can carry RF signals. Alternatively, the trunks may be made up of fiber optic cables, microwave links, and other trunk communication systems. In the latter scenario, scaled down modems and RF/light transceivers may be used to convert digital information into RF/light signals and vice versa. These modems and transceivers may be placed at the CAU 330 with complementary modems and transceivers at each of the BSs 210ᵢ₋ₙ and antenna sites 270ᵢ₋ₙ.

The CAU 330 receives signals generated by the RF converters 236ᵢ₋ₙ of the sector systems 230ᵢ₋ₙ. Each of the RF converters 236ᵢ₋ₙ may be set to specific radio frequencies so as to reduce or avoid signal interference. The frequency bandwidth available to the RF converters 236ᵢ₋ₙ provides the CAU 330 with freedom to interchange/reuse sector systems 230 among the antennas of the wireless network without causing signal interference. In time division applications i.e., TDMA, GSM, reuse of sectors may be higher resulting in a greater number of frequencies that may be needed. Alternatively, in the case of CDMA, one frequency can serve all sector systems in a cell and several cells as well, resulting in a reuse factor of one.

The CAU 330 monitors wireless network performance to determine what times of day there may be excess sector system 230 capacity supporting any one mobile cell 130ᵢ. The CAU 330, in addition to monitoring the wireless network, controls the allocation of sector systems 230ᵢ₋ₙ to antenna sites 270ᵢ₋ₙ within mobile cells 130ᵢ₋ₙ. The CAU 330 makes decisions regarding the reallocation of sector systems 230ᵢ₋ₙ from a particular sector area of a particular mobile cell 130ᵢ with an abundance of sector system 230ᵢ radio capacity to a sector area of a mobile cell that may be in need of sector system 230ᵢ radio capacity.

Based on the capacity characteristics of a wireless network during certain times of day, the CAU 330 may adjust radio capacity of a mobile cell 130ᵢ by taking one or more unallocated sector systems 230ᵢ₋ₙ from an underutilized sector area of a mobile cell 130ᵢ and reallocating these sector systems 230ᵢ₋ₙ to sector areas of mobile cells 130ᵢ₋ₙ that need the extra radio capacity the one or more sector systems 230ᵢ₋ₙ can provide.

In another embodiment, a BS 210ᵢ may have a nominal amount of subscribers and the sector system 230ᵢ could be better utilized supporting another mobile cell 130ᵢ. In such a situation, the CAU 330 could transfer the subscribers from the sector system 230ᵢ the subscribers may be currently affiliated with, to an underutilized adjacent sector system. The transfer may be performed using standard maintenance techniques as is known in the art. Such transfers may be executed prior to a reallocation of the sector system 230ᵢ to another mobile cell 130ᵢ. The CAU 330 directs these transfers by communicating transfer information to supporting BSC 120 SO that as sector system 230ᵢ allocations change throughout a wireless network, transfers may be executed prior to the sector system 230ᵢ allocations. This helps provide a smooth transition of a network and its subscribers during sector system 230ᵢ allocations The transfers may occur in several ways of which three examples are now provided. The transfer may occur in two phases. The first phase including removing the subscribers from a given sector system. The second phase including moving the sector system to another cell.

In the first phase of transfer, the CAU 330 provides an instruction to a BSC 120 supporting a particular sector to not accept any new subscribers. Subscribers using the particular sector system eventually terminate their calls and the sector system becomes available for transfer. Alternatively, the CAU 330 may provide an instruction through or to the BSC 120 that causes subscriber's on a needed sector system to be forcibly handed off to adjacent sectors and the sector system becomes available for transfer. Instructions or messages causing a sector system to not accept further calls are known in the art. Instructions or messages causing subscribers to be forcibly handed off to adjacent cells is known in the art. The CAU 330 may be configured to provide such instructions or messages.

In the second phase of transfer, the CAU 330 provides connectivity between the sector system and the cell to which the sector system is being transferred and sends a message to the BSC 120 that the sector system is available for receiving subscribers. The sector system then begins processing calls for subscribers of the new cell. Instructions or messages alerting the BSC 120 that a sector system is available to receive subscribers is known in the art. The CAU 330 may be configured to provide such instructions or messages.

To address frequency reuse issues, the CAU 330 may be knowledgeable of the frequency ranges of each sector system in the network the CAU 330 supports and may move a sector system of a given frequency range to replace another sector system in the same frequency range. To aid in this type of transfer, sector systems may be allocated, during network planning, frequency ranges beyond that which current radios of the sector system presently support. Such an allocation may allow sector systems with greater bandwidth, but of the same frequency range, to replace a sector system supporting a cell that needs more bandwidth. Conversely, such an allocation may allow sector systems with lesser bandwidth, but of the same frequency range, to replace a sector system supporting a cell that needs less bandwidth.

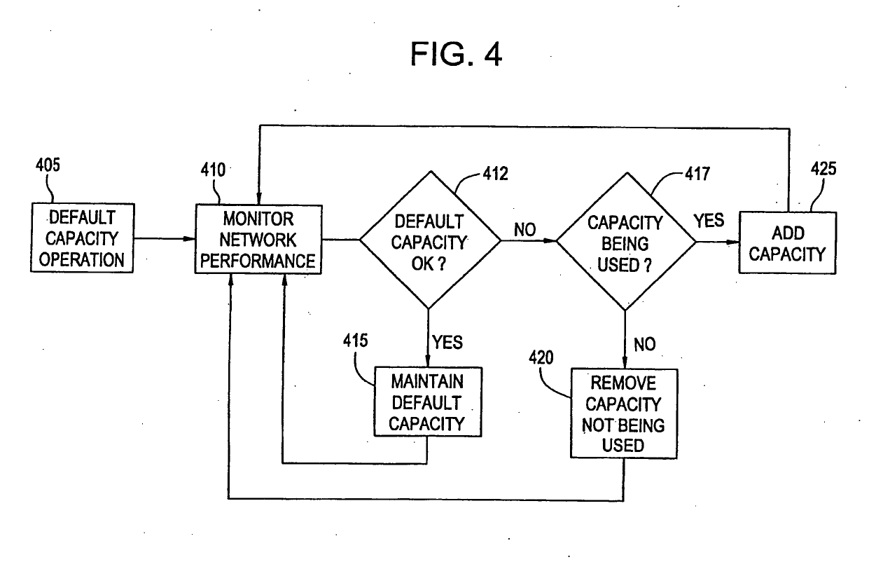

FIG. 4 illustrates a flow diagram for a CAU 330 according to an example embodiment of the invention. At step 405, the CAU 330 dynamically allocates sector systems 230ᵢ₋ₙ using default radio capacity settings. At step 410, the CAU 330 monitors the performance of the wireless network.

If the CAU 330 determines that the default capacity settings are adequate, step 412, the default capacity allocation may be maintained at step 415.

If the CAU 330 determines that not all sector system capacity in a given mobile cell 130ᵢ is being used at step 417, the CAU 330 may remove a sector system 230ᵢ from the mobile cell 130ᵢ and use the sector system 230ᵢ elsewhere or possibly just turn off the sector system 230ᵢ allocated to the mobile cell 130ᵢ to save resources as shown in step 420. In each case, if a sector system 230ᵢ is to be reallocated or turned off and the sector system 230ᵢ still has some subscribers affiliated with it, the subscribers may be transferred or handed off to another sector system prior to reallocating or shutting of the sector system 230ᵢ.

If the CAU 330 determines that a particular mobile cell 130, may be experiencing a high dropped call rate, high blocked call rate, and/or a high error rate typical of a communications system experiencing radio capacity shortages, the CAU 330 can add more radio capacity to the mobile cell 130ᵢ by reallocating a sector system 230i to the needy mobile cell 130ᵢ as shown in step 425.

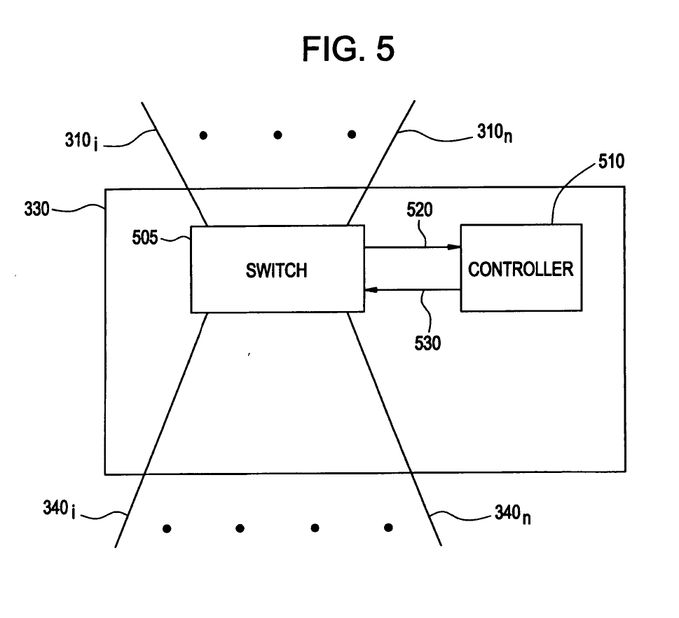

FIG. 5 illustrates a block diagram of a CAU 330 according to an example embodiment of the invention. The CAU 330, as described above, dynamically allocates sector systems 230ᵢ₋ₙ to the antenna sites 270ᵢ of mobile cells 130ᵢ₋ₙ. The CAU 330 may be connected to each of the BSs 210ᵢ₋ₙ and each of the antenna sites 270ᵢ₋ₙ of each of the mobile cells 130ᵢ₋ₙ. The CAU 330 includes a switch 505 and a controller 510.

The switch 505 may be configured to connect sector systems 230ᵢ₋ₙ to antenna sites 270ᵢ₋ₙ using sector system signal lines 250ᵢ₋ₙ and cell communication lines 340ᵢ₋ₙ, respectively. The switch 505 receives commands 530 from the controller 510 and provides the controller 510 with traffic monitoring information 520. The commands 530 may be for the switch 505 itself instructing the switch to connect a particular sector system 230ᵢ to a particular mobile cell 130ᵢ or the commands may be directed to a sector system 230ᵢ including instructions to the sector system 230ᵢ to become idle, shutdown, or force a handoff of a subscriber to another sector system 230ᵢ.

The controller, 510 includes a microprocessor that may be programmed via hardware and/or software to cause the switch 505 to connect particular sector systems 230ᵢ₋ₙ to particular antenna sites 270ᵢ₋ₙ of mobile cells 130ᵢ₋ₙ. The controller receives traffic monitoring information 520 from the switch 505 and sends commands 530 to the switch 505. The controller uses the logic previously disclosed in conjunction with FIG. 4 to make determinations as to which commands to send to the switch 505.

In an alternative embodiment, a network bus may be used in lieu of some of the cell communication lines 340ᵢ₋ₙ and/or sector system signal line 250ᵢ₋ₙ using multiplexing equipment and modems. Using a network bus may be advantageous from a cost perspective.

In an alternative embodiment, the CAU 330 may also be included within a mobile cell 130ᵢ, for example, in a BS 210, supporting the mobile cell 130ᵢ.

In still another alternative embodiment, not all the frequencies of the sector systems 230ᵢ₋ₙ need be different. For example, some of the sector systems 230ᵢ₋ₙ may be dedicated to particular mobile cells 130ᵢ₋ₙ, while other sector systems 230ᵢ may be free for allocation. In such a scenario, certain mobile cells 130ᵢ may never have their sector systems 230ᵢ₋ₙ changed and their associated frequencies would not be susceptible to being interfered with or interfering with other frequencies that may be dynamically allocated among sector systems 230ᵢ₋ₙ.

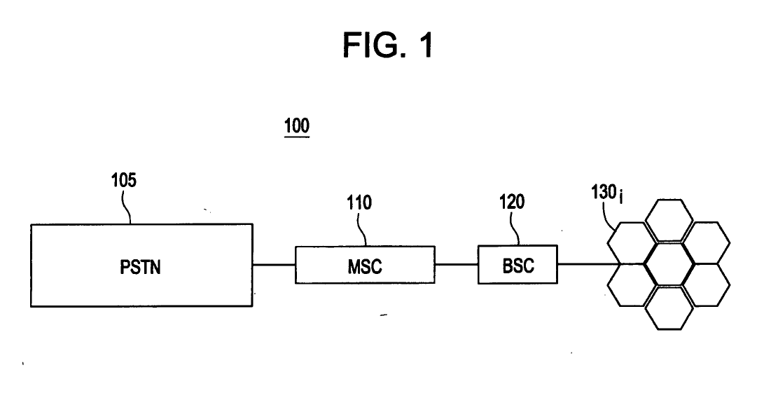

Embodiments of the present invention may help dynamically allocate sector systems 230ᵢ₋ₙ to help reduce wasted radio capacity during non-peak periods in mobile cells 130ᵢ₋ₙ that do not need the radio capacity, improve management and/or improve maintenance of sector systems 230ᵢ₋ₙ. Another advantage may be that existing hardware and functionality as shown in FIGS. 1 and 2 may be reallocated with little to no modification to existing base stations.

It is to be understood that the above description presents illustrative embodiments only. Numerous other arrangements may be devised by one skilled in the art without departing from the scope of the invention.

1. A resource allocation system for a wireless communications system comprising:
a plurality of sector systems; and
an allocation unit configured to allocate at least one sector system of the plurality of sector systems to at least one antenna supporting a cell of a plurality of cells when the cell needs more radio resources to process increased subscriber signal demand.

2. The system of claim 1, wherein, the allocation unit determines when to allocate the at least one sector system based in part on times of historical peak signal traffic.

3. The system of claim 1, wherein the allocation unit includes:
a switch; and
a controller configured to determine when to allocate the at least one sector system based on at least one of time of day and communication traffic loading, the controller configured to provide the switch commands to connect the at least one sector system to at least one antenna supporting the cell when the cell needs more radio resources.

4. The system of claim 3, wherein the switch is configured to switch between sector system signal lines.

5. The system of claim 1, wherein the at least one sector system is positioned outside the cell to which it is allocated.

6. The system of claim 1, wherein the allocation unit reallocates the at least one sector system from at least one cell that does not need the sector system to at least one cell that needs the radio resources of the at least one sector system, the need being based on radio demand.

7. The system of claim 1, wherein the allocation unit sends a command to force a hand-off of a subscriber to free up an allocated sector system of the plurality of sector systems when the allocation unit determines that the allocated sector system is needed to support another cell.

8. The system of claim 1, wherein the allocation unit communicates with each of the cells using at least one of a microwave signal and a light signal.

9. The system of claim 1, wherein the allocation unit communicates with each of the cells over a network bus.

10. The system of claim 1, wherein each of the at least one sector systems includes a plurality of RF converters that are configured to communicate at different radio frequencies.

11. A method comprising:
determining that a cell of a plurality of cells needs more radio resources; and
allocating at least one sector system of a plurality of sector systems to at least one antenna supporting the cell when the cell needs more radio resources to process increased subscriber signal demand.

12. The method of claim 11, wherein the determining step determines that the cell needs more radio resources based on times of historical peak signal traffic.

13. The method of claim 11, wherein the allocating step includes:
sending a command to connect at least one of the sector systems to at least one antenna supporting the cell when the cell needs more radio resources; and
connecting at least one of the sector systems to at least one antenna supporting the cell when the cell needs more radio resources.

14. The method of claim 13, wherein the connecting step includes connecting sector system signal lines that carry combined signals.

15. The method of claim 11, further comprising:
positioning the at least one sector system outside the cell to which it is to be allocated.

16. The method of claim 11, further comprising:
reallocating the at least one sector system from a cell that does not need the radio resources of the sector system to a cell that needs the radio resources.

17. The method of claim 11, further comprising:
determining that another cell needs the at least one sector system; and
sending a command to force a hand-off of a subscriber to free up an underutilized sector system of the plurality of sector systems when the determining step determines that the other cell needs the underutilized sector system.

18. The method of claim 11, further comprising:
communicating with each of the cells using at least one of a microwave signal and a light signal.

19. The method of claim 11, further comprising:
communicating with each of the cells over a network bus.

20. The method of claim 11, further comprising:
configuring each of the plurality of RF converters within each of the sector systems to communicate at different radio frequencies.

21. A resource allocation system for a wireless communications system comprising:
a plurality of sector systems; and
an allocation unit configured to allocate at least one sector system of the plurality of sector systems, the at least one sector system supporting a first cell, to at least one antenna supporting a second cell of a plurality of cells when the second cell is determined to need more radio resources to process increased subscriber signal demand.

22. A resource allocation system for a wireless communications system comprising:
an allocation unit configured to dynamically allocate at least one sector system of a first cell to a second cell.

23. A method comprising:
allocating at least one sector system of a first cell to a second cell.
